(19) United States
(12) Patent Application Publication
(10) Pub. No.: US 2022/0079379 A1
(43) Pub. Date: Mar. 17, 2022

(54) FOOD WARMING SYSTEM

(71) Applicant: Joseph Ganahl, Honolulu, HI (US)

(72) Inventor: Joseph Ganahl, Honolulu, HI (US)

(21) Appl. No.: 17/536,049

(22) Filed: Nov. 28, 2021

Related U.S. Application Data
(63) Continuation-in-part of application No. 16/459,795, filed on Jul. 2, 2019.

(51) Int. Cl. A47J 36/24; A47J 47/14; A47J 36/02; A23L 3/28; A47J 36/10; A47J 36/38

(52) U.S. Cl. CPC A47J 36/2483; A47J 47/14; A47J 36/38; A23L 3/28; A47J 36/10; A47J 36/025

(57) ABSTRACT

The embodiments disclose a method including warming food in an integral heat tray insert of a food container, generating heat in the food container using electrical impedance of a plurality of heat dispersing elements, using a control printed circuit board assembly coupled to a power button for activating and controlling electrical components including the plurality of heat dispersing elements, adjusting heat temperatures from the plurality of heat dispersing elements for warming food to a comfortable and safe heat level, using at least one rechargeable battery pack coupled to the control printed circuit board assembly with a power button for activating electrical components including the plurality of heat dispersing elements, and transmitting food status information to a user and receiving user instructions from a user digital device using a food warming system application which includes a timer and variable heat control.

### CROSS-REFERENCE TO RELATED APPLICATIONS

This patent application is a continuation-in-part and claims priority to U.S. Non-Provisional patent Ser. No. 16/459,795 filed Jul. 2, 2019, entitled “FOOD WARMING SYSTEM” by Joseph Ganahl, the U.S. patent application being incorporated herein by reference. This application claims priority to U.S. Provisional Patent Application Ser. No. 62/694,981 filed Jul. 7, 2018, entitled “FOOD WARMING SYSTEM”, by Joseph Ganahl, the U.S. patent application being incorporated herein by reference.

### BACKGROUND

Food spoilage is a natural occurring process. When food is subjected to temperatures in the “danger zone” above 40° F. and below 140° F. the toxins multiple at an exponential rate. The toxins in turn leave bacteria on your food. Bacteria, yeasts and molds are among common causes of spoilage and food poisoning. Chilling food helps delay the food poisoning and spoiling process because the toxins grow at a slower rate, thus leaving fewer bacteria, and keeping food safe to eat for a longer period of time. Many portable containers are available to keep food chilled for a period of time. One impact of chilling food is that it can impact sensory details such as texture, taste and smell. Human beings evolved to prefer hot food. Warmth enhances flavor on the sensory papillae of our tongues and heating food boosts its energy value.

### BRIEF DESCRIPTION OF THE DRAWINGS

FIG. 1 shows for illustrative purposes only an example of an overview of a food warming system container of one embodiment.

FIG. 2 shows for illustrative purposes only an example of a waterproof power button of one embodiment.

FIG. 3 shows for illustrative purposes only an example of a heat tray insert of one embodiment.

FIG. 4 shows for illustrative purposes only an example of a control printed circuit board assembly (PCBA) of one embodiment.

FIG. 5 shows for illustrative purposes only an example of a rechargeable battery pack of one embodiment.

FIG. 6 shows for illustrative purposes only an example of waterproof LED indicators of one embodiment.

FIG. 7 shows for illustrative purposes only an example of an exposed charge port of one embodiment.

FIG. 8 shows for illustrative purposes only an example of a food status audible and visual alert broadcast of one embodiment.

FIG. 9 shows for illustrative purposes only an example of a temperature control of one embodiment.

FIG. 10 shows for illustrative purposes only an example of a cover food ready alert LED of one embodiment.

FIG. 11 shows for illustrative purposes only an example of heat dispersing elements of one embodiment.

FIG. 12A shows for illustrative purposes only an example of food warming system food container cover and insert wall structures of one embodiment.

FIG. 12B shows for illustrative purposes only an example of a food warming system food container heat tray insert bottom structure of one embodiment.

FIG. 12C shows for illustrative purposes only an example of a PCBA insert wall structure of one embodiment.

FIG. 13 shows for illustrative purposes only an example of a waterproof bento box of one embodiment.

FIG. 14 shows for illustrative purposes only an example of a replaceable tray bento box of one embodiment.

FIG. 15 shows for illustrative purposes only an example of a removable battery of one embodiment.

FIG. 16 shows for illustrative purposes only an example of an integral tray of one embodiment.

FIG. 17 shows for illustrative purposes only an example of a temperature display of one embodiment.

FIG. 18 shows for illustrative purposes only an example of a rechargeable battery of one embodiment.

FIG. 19A shows for illustrative purposes only an example of bento box cross section markers of one embodiment.

FIG. 19B shows for illustrative purposes only an example of bento box cross section of one embodiment.

FIG. 20 shows for illustrative purposes only an example of hot bento box app of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of a food warming system is described for illustrative purposes and the underlying system can apply to any number and multiple types of foods. In one embodiment of the present invention, the food warming system can be configured using a PCBA with electronic and digital devices. The food warming system can be configured to include real-time temperature monitoring and can be configured to include rechargeable batteries using the present invention.

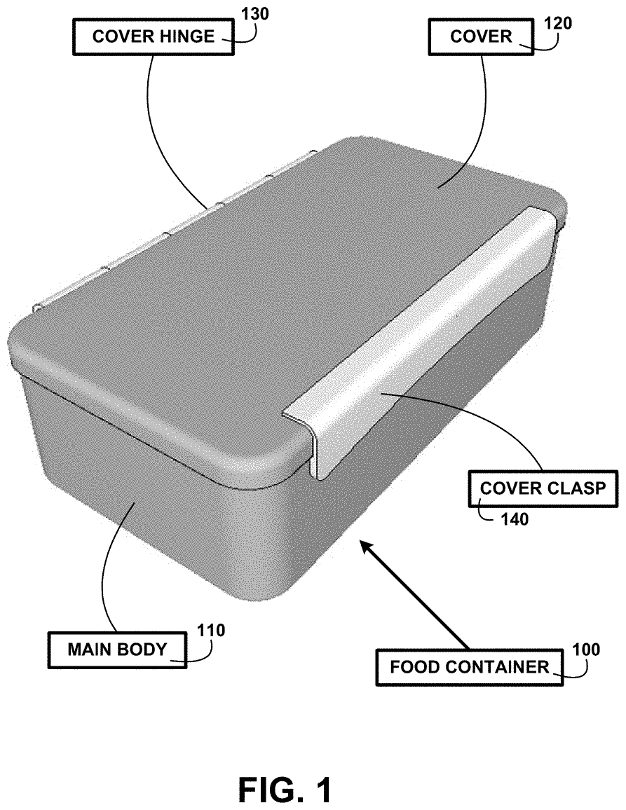

FIG. 1 shows for illustrative purposes only an example of an overview of a food warming system container of one embodiment. FIG. 1 shows a food warming system food container 100 in a closed position including a main body 110 and cover 120 to prevent outside contamination while in operation of warming food. The cover 120 includes a cover hinge 130 coupled to the main body 110 for opening and closing the food container 100 and a cover clasp 140 to securely seal the food container when closed in locked position of one embodiment.

The food warming system is a portable container for storing chilled food with an integral heating system to warm the food when ready to eat. The food container 100 is the main container designed for food storage. The food container 100 has a main body 110 which is a concave cavity where food is stored. A cover 120 seals the main body 110 closed to prevent food escaping. The cover 120 may be hinged and secured with a single clasp or completely removable and sealed with 4 clasps, one on each side or other closure and seal systems. A heat tray insert is integrated inside the main body and contains all the elements for heating food. A rechargeable battery pack provides power to operate the system of one embodiment.

The rechargeable battery pack is directly connected to a control printed circuit board assembly (PCBA) which controls power flow, temperature, charging and all battery safety protocols. A power button is also connected to the PCBA and is used to activate the system. When the system is activated, electrical power flows though the PCBA and is converted to heat which is then distributed along the heat tray insert foil tape or other conductors that surrounds food. A series of LED indicators are also connected to the PCBA and show a power level of the rechargeable battery pack. Charging the rechargeable battery pack is accomplished via a battery charge port. When not in use the battery charge port is sealed with a waterproof cover to prevent moisture leakage into the battery charge port. The waterproof cover is removed for charging and a charger plug is inserted into the battery charge port of one embodiment.

The food warming system food container forms a self-contained, lightweight, compact, battery powered, food safe, waterproof compartment with surrounding heat elements, adaptable to virtually any food container type. In another embodiment the food warming system devices are configured for keeping foods placed inside cold. The food warming system container may be fabricated using stainless steel or aluminum interior insulated walls with exterior plastic jacketing. The exterior plastic jacketing may be fabricated using plastic injection, co molded silicone injection, Surface Mount (SMT) assembly providing low cost and scalable manufacturing systems of one embodiment.

### DETAILED DESCRIPTION

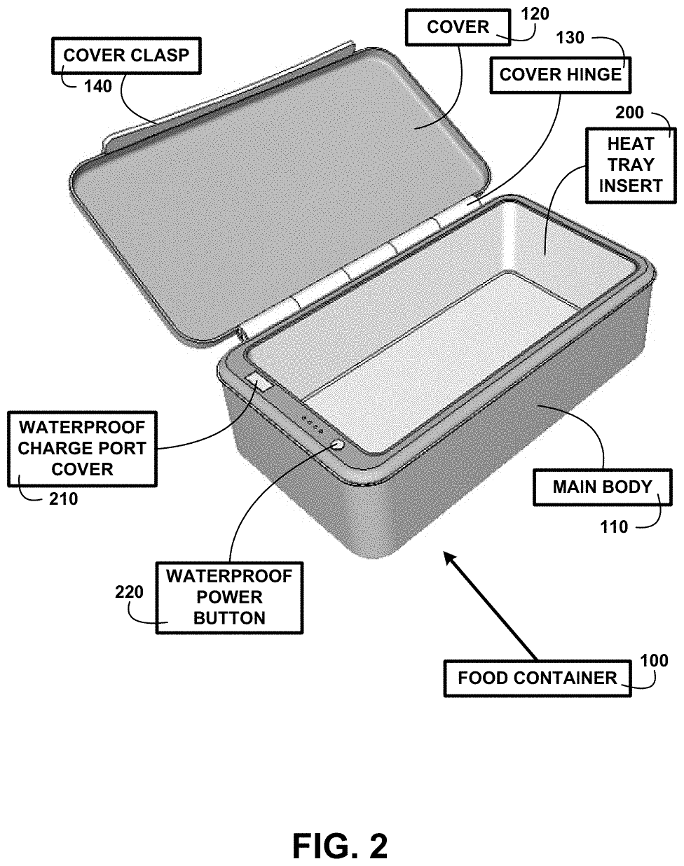

FIG. 2 shows for illustrative purposes only an example of a waterproof power button of one embodiment. FIG. 2 shows the food container 100, main body 110, cover 120 in an opened position, cover hinge 130, and the cover clasp 140 unlocked. A heat tray insert 200 is shown integrated into the food container 100. A waterproof charge port cover 210 is shown with a waterproof cover installed. A waterproof power button 220 is used to activate and deactivate the heating and control systems. The waterproof power button 220 waterproofing prevents moisture from entering the power circuits and created a short of one embodiment.

The food warming system devices are configured to be easily portable so that food can be warmed anywhere. The food warming system devices are self-contained, food safe and waterproof so that foods with liquids will not damage the system. Power is supplied by a customized rechargeable battery pack. Heating power, charging and battery safety circuits are all contained in the PCBA. When the system is activated the PCBA will convert electrical energy to heat energy and disperse it through conductors including for example foil tape conductors or other conductors of one embodiment.

These conductors are placed along the walls and bottom of the heat tray insert 200 and, in some embodiments, along the cover inside surface. The heat elements completely surround the food and transfer heat into the food for warming. The food warming system heating systems are attached to a stainless steel or aluminum shell and heat is transmitted through shell directly to the food which is placed within the stainless steel shell by generating heat in the food container using the electrical impedance of a plurality of heat dispersing elements one embodiment.

The food warming system devices may be configured in shapes and sizes for various food types and natures for example round, oblong or other shapes and sizes. For example one shape and size for a typical sandwich with square shaped bread slices, in another example where the interior space is compartmentalized to separate for example soups from dry foods. In other embodiments the food warming system devices may be configured for specific user activities for example travel in a commercial airlines where the rechargeable battery pack is of a type and design that meet TSA regulations, the food container seals when closed prevent any leakage, and the cover clasp 140 is configured to be child-proof and cannot be accidentally opened by contact with other objects.

In yet other embodiments the food warming system devices may be configured for keeping foods placed inside cold for example ice creams, fresh fruit and salads to prevent wilting and maintaining the food below 40° F. to prevent bacterial growth until the user is ready to warm the food if desired.

### A Heat Tray Insert:

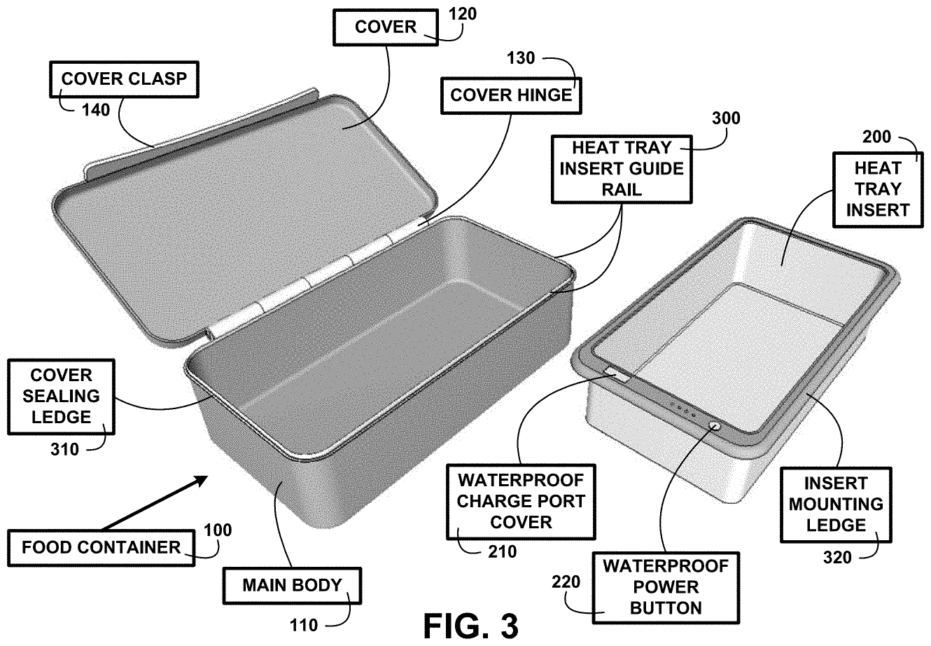

FIG. 3 shows for illustrative purposes only an example of a heat tray insert of one embodiment. FIG. 3 shows the food container 100, main body 110, cover 120 in an opened position, cover hinge 130, and unlocked cover clasp 140 with the integral heat tray insert 200 removed and set alongside. The waterproof charge port cover 210 and waterproof power button 220 can be seen on one side of a heat tray insert mounting ledge 320. The heat tray insert guide rail 300 is configured to provide a cover sealing ledge 310 of one embodiment.

### A Control Printed Circuit Board Assembly (PCBA):

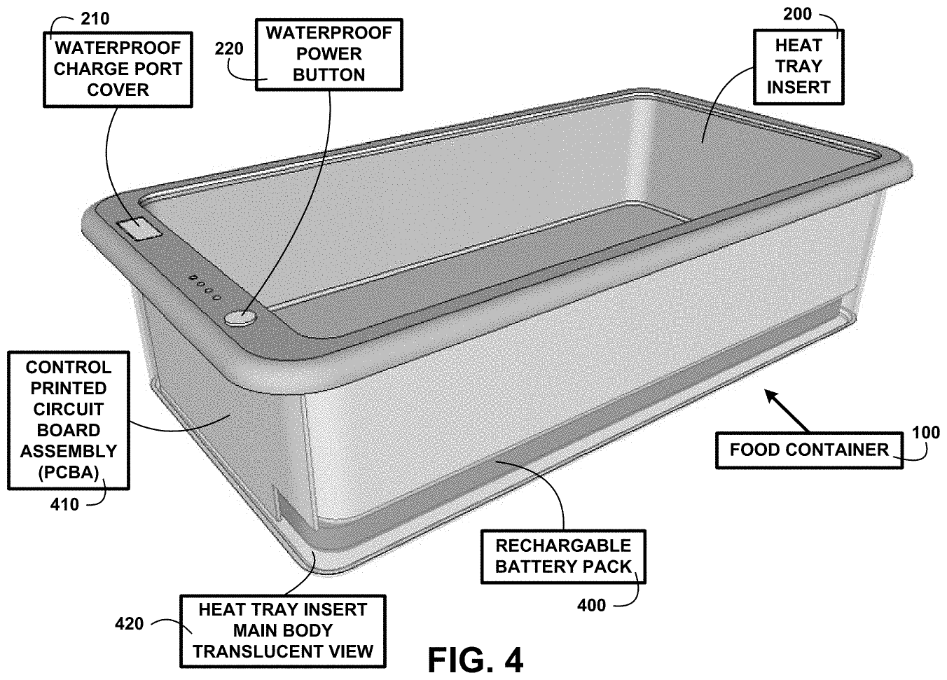

FIG. 4 shows for illustrative purposes only an example of a control printed circuit board assembly (PCBA) of one embodiment. FIG. 4 shows the food container 100 heat tray insert 200 with a heat tray insert main body translucent view 420 of exterior wall surfaces for illustrative purposes only. Also seen are the waterproof charge port cover 210 and waterproof power button 220. Showing underneath the heat tray insert 200 inner surface is a rechargeable battery pack 400. Showing inside the translucent wall is at least one control printed circuit board assembly (PCBA) 410 in this example at one end of the heat tray insert 200.

The control printed circuit board assembly (PCBA) 410 is electrically coupled to the rechargeable battery pack 400. The control printed circuit board assembly (PCBA) 410 is coupled to a battery charge level device and an infrared thermometer sensor for monitoring food temperature in real time.

The control printed circuit board assembly (PCBA) 410 includes at least one digital processor, at least one digital memory device, at least one database; at least one infrared thermometer coupled to the PCBA, at least one chemical vapor sensing device, at least one circuit coupled to the food container 100 cover 120, at least one circuit coupled to at least one digital temperature display, at least one circuit coupled to an alert light coupled to the cover 120, and at least one circuit coupled to a temperature control selection device mounted on the heat tray insert 200 insert mounting ledge 320.

The at least one chemical vapor sensing device is used to analyze odors from the food placed in the heat tray insert 200. The at least one chemical vapor sensing device detects the chemical signatures of spoiled food odors, food borne pathogens for example salmonella and other food conditions that may cause a food consumer to become ill or even die. The chemical vapor sensing device coupled to the control printed circuit board assembly (PCBA) 410 performs the chemical analysis to determine the chemical formulae of the vapor elements.

The at least one digital processor is used to search at least one digital memory device database for the identity of the chemical formulae from the chemical compound data prerecorded and stored in that database. Should the identified chemical formulae be a categorized as a health hazard, the PCBA will transmit an alert to the user to dispose of the food and not eat the food and identifying the potential health hazard detected. Embodiments may include using the at least one digital memory device database for recording data on various food stuffs to include recipe ingredients, characteristics, visual examples, cooking instructions with minimum food safety temperatures, precautions, spoilage indications and signs, and other information for keeping foods safe for consumption.

In another embodiment the identified chemical formulae is transmitted to a food warming system digital application on a user's digital device. The food warming system digital application is configured to perform an internet search for information to determine if the identified chemical formulae are categorized as a health hazard. The food warming system digital application will automatically display a visual warning and broadcast an audible alert to the user regarding the potential health hazard that has been determined.

In another embodiment the user may enter the type of food to be placed in the food warming system into the food warming system digital application installed on the user's digital device. The food warming system digital application will perform a search and display recipe ingredients, characteristics, visual examples, cooking instructions with minimum food safety temperatures, precautions, spoilage indications and signs, and other information for keeping foods safe for consumption.

The control printed circuit board assembly (PCBA) 410 includes at least one cellular connectivity device and transceiver for transmitting food status signal alerts, battery charge alerts and receiving user turn-off instructions. The control printed circuit board assembly (PCBA) 410 includes connectivity devices to Bluetooth® and Wi-Fi to provide communication and control alternatives to the user including voice activated commands.

A rheostat device for regulating power levels conducting battery energy to a plurality of heat dispensing elements is also controlled by the control printed circuit board assembly (PCBA) 410 of one embodiment. The rechargeable battery pack 400 provides power to operate the food warming system components. The control printed circuit board assembly (PCBA) 410 controls power flow, temperature, charging and all battery safety protocols. The waterproof power button 220 is also coupled to the control printed circuit board assembly (PCBA) 410 and rechargeable battery packs 400 and is used to activate the system. When the system is activated, electrical power flows though PCBA and is converted to heat which is then distributed along the heat tray insert 200 conductors that surround food placed inside the heat tray insert 200. The LED indicators are also connected to PCBA and show power levels of the rechargeable battery pack 400 of one embodiment.

### A Rechargeable Battery:

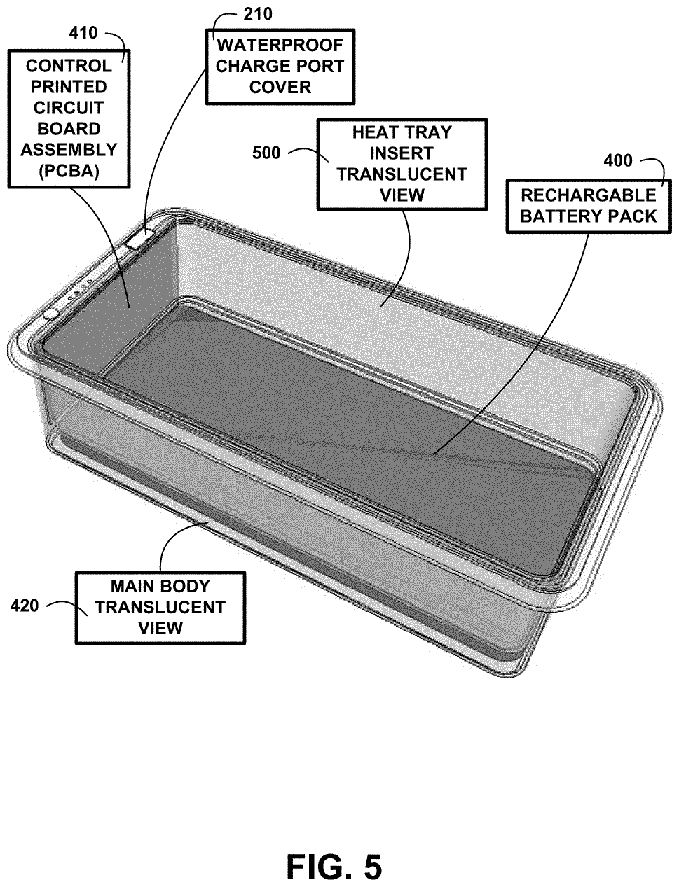

FIG. 5 shows for illustrative purposes only an example of a rechargeable battery pack of one embodiment. FIG. 5 shows a heat tray insert translucent view 500 and the main body translucent view 420 for illustrative purposes only. The waterproof charge port cover 210 is seen coving the charge port not showing. The rechargeable battery pack 400 may include for example a lithium ion rechargeable battery pack, lithium polymer (LiPo) rechargeable battery, rechargeable aluminum-based batteries, rechargeable nickel-iron battery and other rechargeable battery types. The control printed circuit board assembly (PCBA) 410 may include a plurality of printed circuits configured for differing functions including electronic components and circuits for controlling the various food warming system operations as described above and in the following descriptions. The control printed circuit board assembly (PCBA) 410 includes multiple safety systems for battery charging and operation of one embodiment.

### Waterproof LED Indicators:

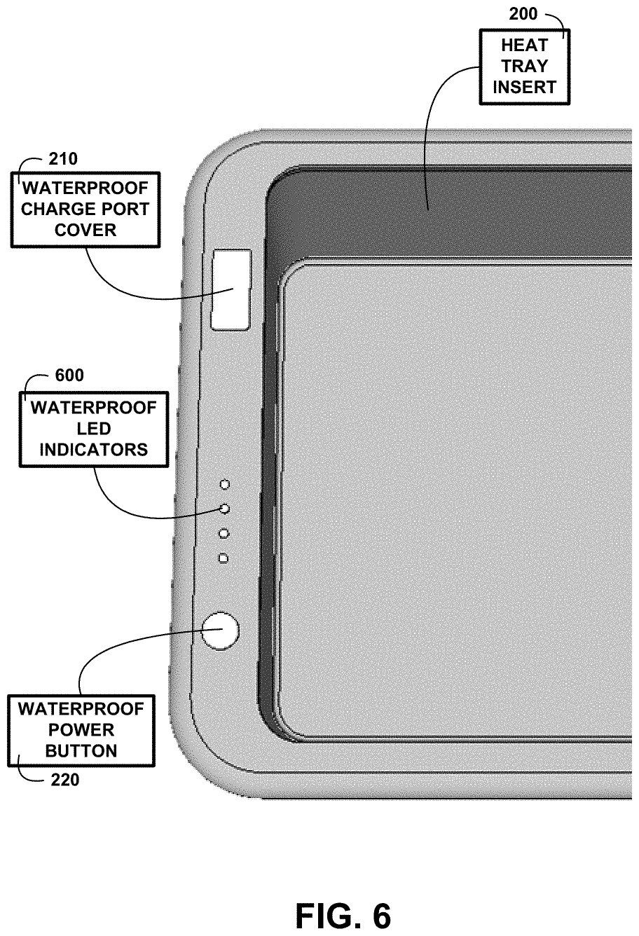

FIG. 6 shows for illustrative purposes only an example of waterproof LED indicators of one embodiment. FIG. 6 shows the heat tray insert 200 with the waterproof charge port cover 210 and waterproof power button 220. Also seen are a series of waterproof LED indicators 600. The waterproof LED indicators 600 include LED lights in for example a series of different colors to indicate the current battery charge of the rechargeable battery pack 400 of FIG. 4. The control printed circuit board assembly (PCBA) 410 of FIG. 4 is configured to transmit battery charge alert signals to a user's digital device to make them aware of a possible action to connect the rechargeable battery pack 400 of FIG. 4 to an external power source for recharging using the charging port and a charger plug of one embodiment.

### An Exposed Charge Port:

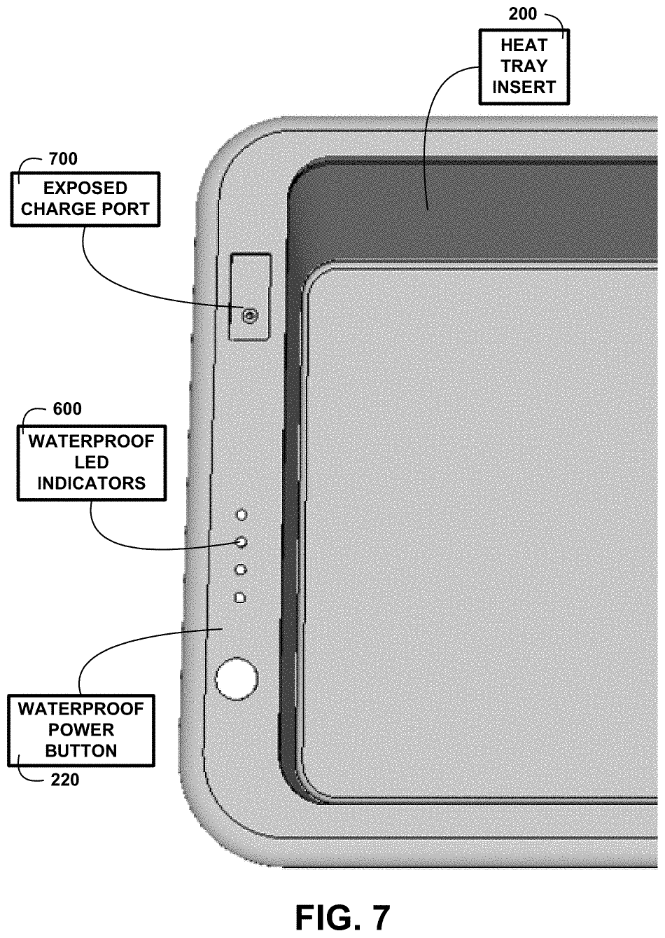

FIG. 7 shows for illustrative purposes only an example of an exposed charge port of one embodiment. FIG. 7 shows the waterproof power button 220, waterproof LED indicators 600 and heat tray insert 200 with an exposed charge port 700 wherein the waterproof charge port cover 210 of FIG. 2 has been removed. The waterproof charge port cover 210 of FIG. 2 is removed when the rechargeable battery pack 400 of FIG. 4 is being recharged using a charger plug connected to an external power source and is plugged into the exposed charge port 700 of one embodiment.

### A Food Status Audible and Visual Alert Broadcast:

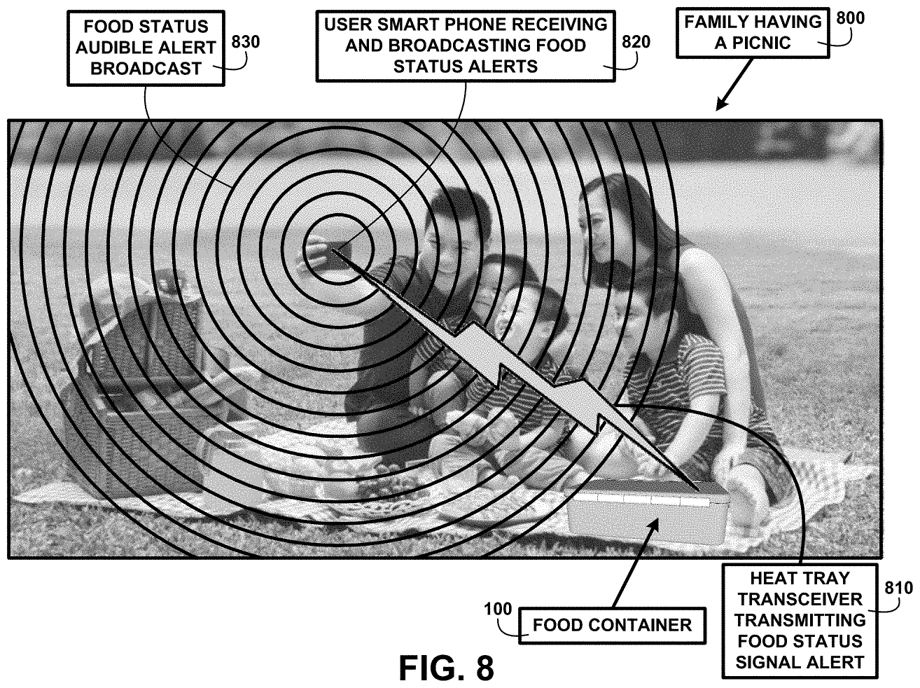

FIG. 8 shows for illustrative purposes only an example of a food status audible and visual alert broadcast of one embodiment. FIG. 8 shows the food warming system food container 100 being used by a family having a picnic 800. During the period of time the food is being heated to a safe temperature the users may be engaged in a physical activity or for example as shown taking a selfie of the fun time they are enjoying having a picnic. These activities may distract the family member that placed the food into the food container 100 for warming.

To alert that person that the food is ready to be served a heat tray transceiver transmitting food status signal alert 810 to the user digital device provides notice that the food is ready. In addition the heat tray transceiver is configured to include transmitting a food status audible alert broadcast 830. The heat tray transceiver food status signal alert 810 and food status audible alert broadcast 830 using cellular connectivity provides signals for a user digital device including a user smart phone receiving and broadcasting food status alerts 820 to alert the user to attend to the food warming status.

The food warming system includes a food warming digital application for installing on a user's digital device including for example a smart phone, tablet, laptop computer and other digital devices. The food warming digital application installed on a user's digital device is configured for displaying the food status alerts on a digital screen and broadcasting audible food status alerts. The user can tap the food warming digital application icon and receive intermediate food status alerts to check the current temperature and a calculated approximate time remaining for the food to reach a safe temperature.

In one embodiment the food warming digital application may display the temperature selection controls of the food warming food container. This allows the user to set the desired temperature using the user's digital device. The user may want to turn off or adjust the temperature which they can perform using the food warming digital application of one embodiment.

### A Temperature Control:

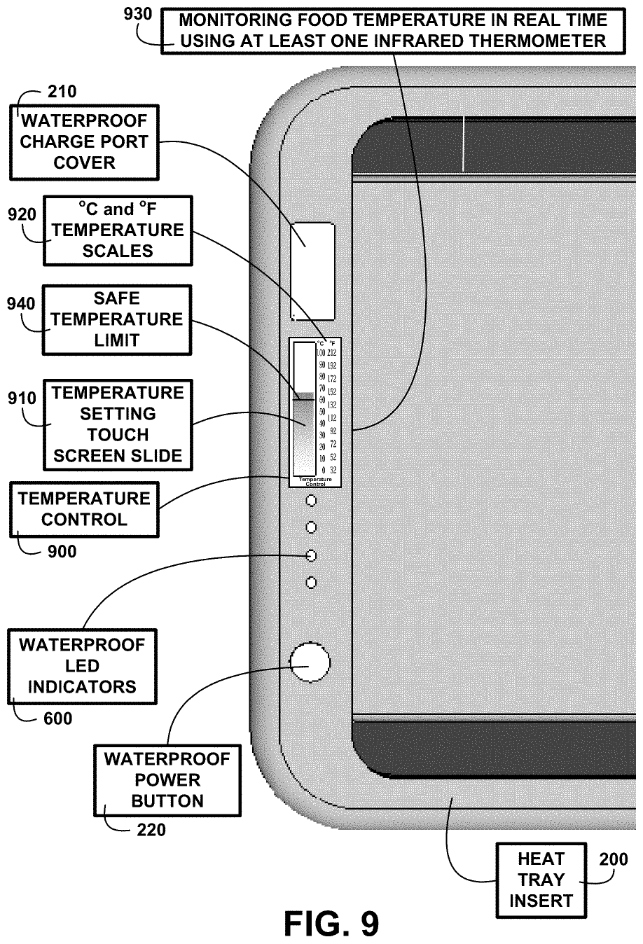

FIG. 9 shows for illustrative purposes only an example of a temperature control of one embodiment. FIG. 9 shows the heat tray insert 200, waterproof power button 220; waterproof LED indicators 600 and the waterproof charge port cover 210. Also shown is a temperature control 900. The temperature control 900 is coupled to the control printed circuit board assembly (PCBA) 410 of FIG. 4. The temperature control 900 is configured for the user to set a temperature for warming the food placed in the food warming system.

The temperature control 900 includes a temperature setting touch screen slide 910 adjusting feature. The temperature setting touch screen slide 910 is adjustable using degrees Celsius and degrees Fahrenheit temperature scales 920. The temperature control 900 includes monitoring food temperature in real time using at least one infrared thermometer 930 that is coupled to the control printed circuit board assembly (PCBA) 410 of FIG. 4 and temperature control 900. The temperature setting touch screen slide 910 includes a safe temperature limit 940 indicating line to remind the user not to set a temperature above that limit of one embodiment.

In another embodiment the temperature control 900 includes digital touch buttons labeled for specific food types for example soups, sandwiches, stews, vegetables, and others. The digital touch buttons labeled for specific food types when pressed will set the targeted temperature setting to preset temperatures prerecorded in one of the at least one databases.

### A Cover Food Ready Alert LED:

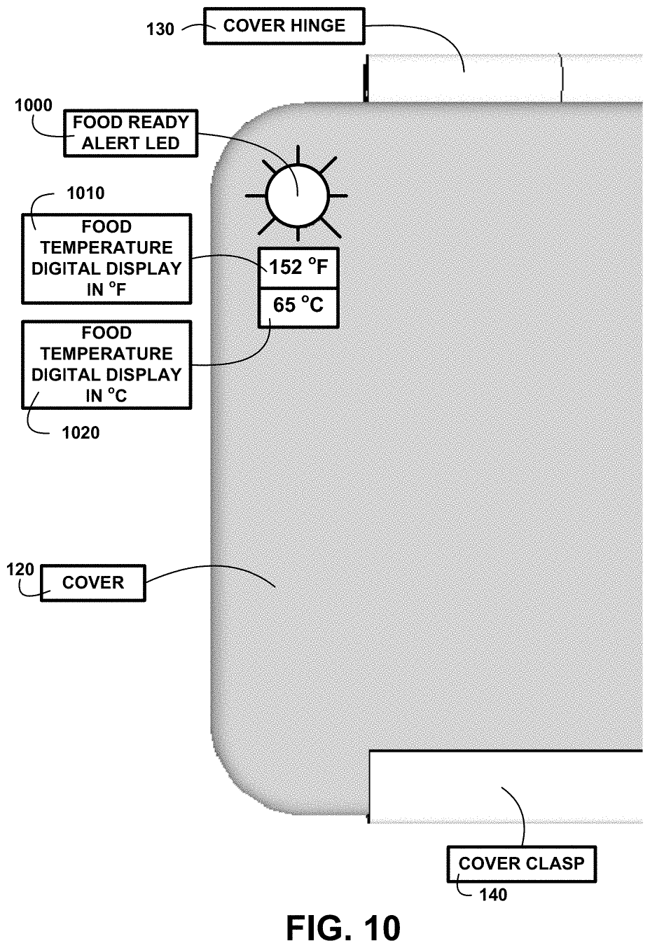

FIG. 10 shows for illustrative purposes only an example of a cover food ready alert LED of one embodiment. FIG. 10 shows the food container 100 cover 120, cover hinge 130 and cover clasp 140. In one embodiment the cover 120 includes a food ready alert LED 1000, a food temperature digital display in degrees Fahrenheit 1010 and a food temperature digital display in degrees Celsius 1020.

The food status audible alert broadcast 830 of FIG. 8 can be heard by a user with a visual impairment. The food ready alert LED 1000, food temperature digital display in degrees Fahrenheit 1010 and food temperature digital display in degrees Celsius 1020 can be seen by users with hearing impairments. In another embodiment the temperature readings in degrees Fahrenheit and degrees Celsius may be electronic vocalizations using a text reader. This feature can be configured to broadcast the electronic vocalizations in languages selected by the user using the food warming digital application of one embodiment.

### Heat Dispersing Elements:

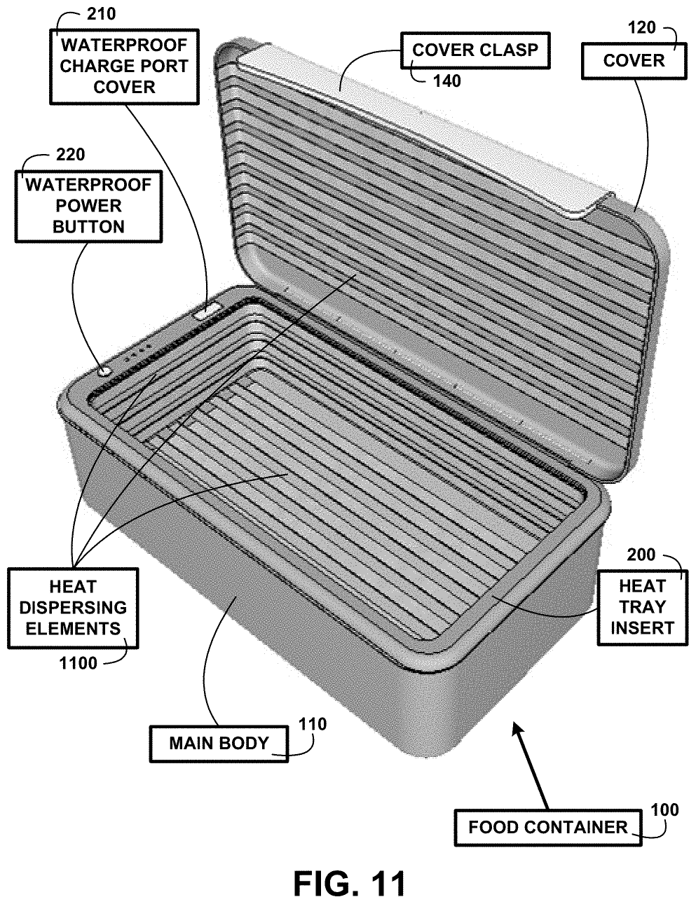

FIG. 11 shows for illustrative purposes only an example of heat dispersing elements of one embodiment. FIG. 11 shows the food container 100 including the main body 110, cover 120, cover clasp 140, heat tray insert 200, waterproof charge port cover 210 and waterproof power button 220. Also showing is a plurality of heat dispersing elements 1100 exposed for illustrative purposes only. The plurality of heat dispersing elements 1100 are heat tray insert conductors positioned to surround food placed in the food container with the heat tray insert. The interior surfaces of the food container and heat tray insert are stainless steel. The conductors are positioned directly beneath the stainless steel interior enclosure structures and conduct heat directly through the stainless steel material to warm the food placed against and near the interior surfaces.

When the system is activated, electrical power from the rechargeable battery pack 400 of FIG. 4 flows though the at least one control printed circuit board assembly (PCBA) 410 of FIG. 4 and is converted to heat through the electrical impedance of the conductors. The control printed circuit board assembly (PCBA) 410 of FIG. 4 uses the real-time temperature monitoring of the at least one infrared thermometer 930 of FIG. 9 to regulate the amperage and voltage flowing to each of the conductors. Regulating the amperage and voltage flowing to each of the conductors controls the heat produced by the electrical impedance for adjusting the heat emanating from the plurality of heat dispersing elements 1100 in the interior surface regions to provide even heating of the food.

In another embodiment the heat tray insert 200 and food container 100 cover 120 include ultraviolet (UV) lights to treat the food placed in the heat tray insert 200 to kill bacteria, viruses and other food borne pathogens and sterilize the food before, during and after the warming processes.

### Food Warming System Food Container Cover and Insert Wall Structures:

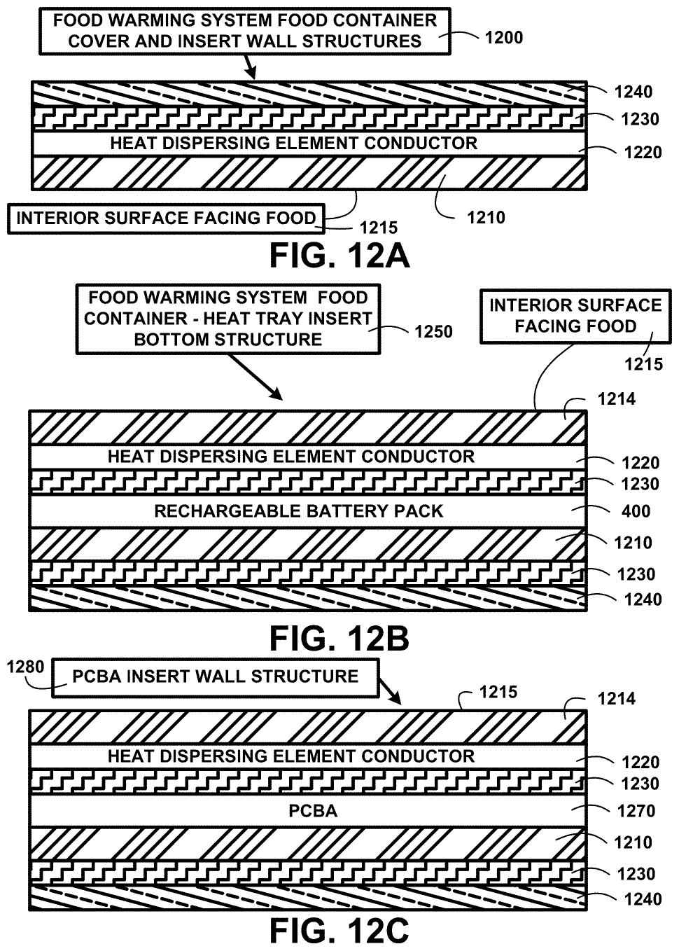

FIG. 12A shows for illustrative purposes only an example of food warming system food container cover and insert wall structures of one embodiment. FIG. 12A shows food warming system food container cover and insert wall structures 1200. The wall structures include a stainless steel shell 1210 that provides an interior surface facing food 1215 that is placed in the food warming system. Also showing is a heat dispersing element conductor 1220 that is attached to the stainless steel shell 1210 and coupled to the at least one control printed circuit board assembly (PCBA) 410 of FIG. 4. The wall structures include an insulation 1230 layer that is surrounded by an exterior plastic jacket 1240 of one embodiment.

### A Food Warming System Food Container Heat Tray Insert Bottom Structure:

FIG. 12B shows for illustrative purposes only an example of a food warming system food container heat tray insert bottom structure of one embodiment. FIG. 12B shows a food warming system food container heat tray insert bottom structure 1250. The insert bottom structure includes an interior surface facing food 1215 of an inner stainless steel shell 1214 with a heat dispersing element conductor 1220 attached. An insulation 1230 layer is positioned between the heat dispersing element conductor 1220 and rechargeable battery pack 400. An outer stainless steel shell 1210 provides exterior support and includes an insulation 1230 layer with an exterior plastic jacket 1240 of one embodiment.

### A PCBA Insert Wall Structure:

FIG. 12C shows for illustrative purposes only an example of a PCBA insert wall structure of one embodiment. FIG. 12C shows a PCBA insert wall structure 1280 showing in a horizontal orientation for illustrative purpose, but is normally in a vertical orientation at one end of the food container. The PCBA insert wall structure 1280 includes an interior surface facing food 1215 of the inner stainless steel shell 1214. A heat dispersing element conductor 1220 is shown attached to the inner stainless steel shell 1214 for transmitting heat through the inner stainless steel shell 1214 to warm the food placed in the food warming system food container. An insulation 1230 layer is placed between the PCBA 1270 and the heat dispersing element conductor 1220. The outer stainless steel shell 1210 is used for providing exterior support and for supporting the PCBA 1270 attachment. A second insulation 1230 layer is positioned between the outer stainless steel shell 1210 and the exterior plastic jacket 1240 of one embodiment.

### A Waterproof Bento Box:

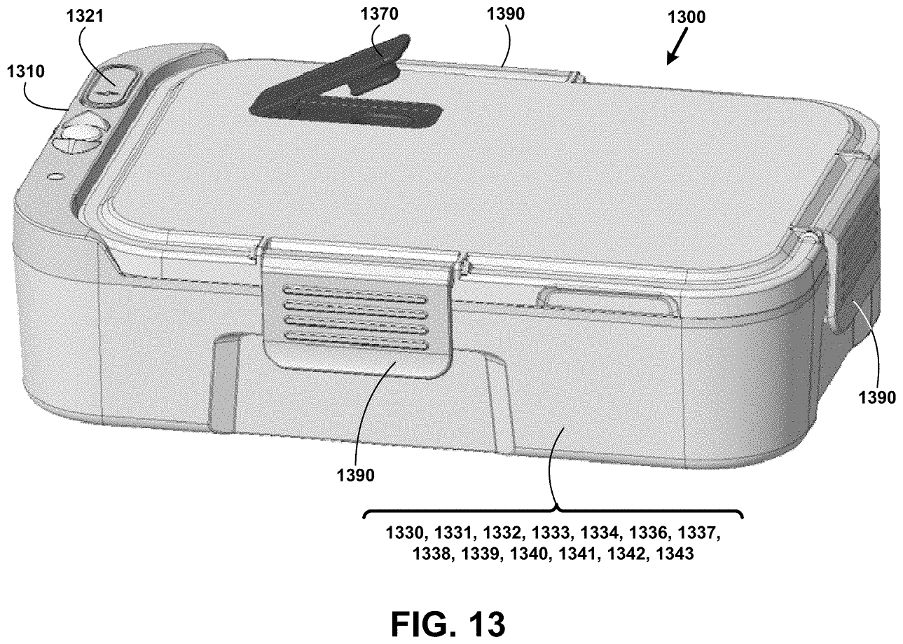

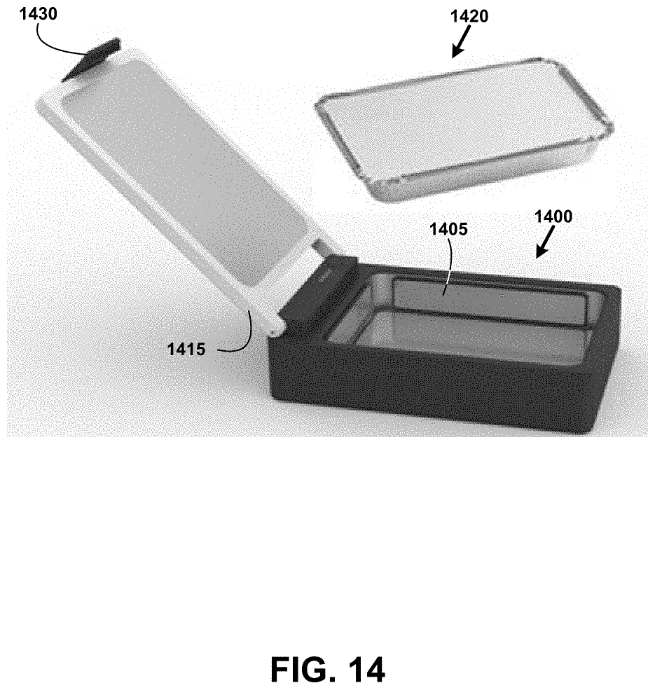

FIG. 13 shows for illustrative purposes only an example of a waterproof bento box of one embodiment. FIG. 13 shows a waterproof bento box 1300. The waterproof bento box 1300 includes a waterproof charge cover 1310 to prevent spillage of the fluid contents. A pressure equalization valve 1370 integrated into the waterproof charge cover 1310 prevents pressure from heating the contents to build up, to alleviate pressure when closing cover, release pressure from steam, improve conductive circulation to decrease heating times and increase attainable temperatures. The pressure equalization valve will automatically open to release excessive steam buildup.

A waterproof power button with protective ridges 1321 is used to turn on and off the waterproof bento box 1300. The protective ridges prevents content fluid from leaking into the power system and avoids short-circuits. The waterproof power button with protective ridges includes a double tap requirement to prevent accidental ON. The waterproof charge cover 1310 includes a plurality of a latch 1390 to on multiple sides to secure the waterproof charge cover 1310 while heating the contents and while carrying the waterproof bento box 1300.

This embodiment of the waterproof bento box 1300 includes a plurality of features including a 3 way power supply: 110-240 v ac, 12 v dc, battery 1330 with independent protective circuits and resistors for each power source 1331. A removable/replaceable battery 1332 provides one of the power supplies. User convenience is provided with an adapter to use batteries from popular hand tool brands 1333. For example workers at a construction site can use some of the same batteries powering their tools to power the waterproof bento box 1300 for a hot lunch.

A Teflon™ coating of stainless steel or aluminum tray for a non-stick surface 1334. This facilitates cleaning the waterproof bento box 1300. A removable food tray 1336 provides the capability of a user to purchase various prepared meal kits in the removable food tray 1336 space for the user to have access to a menu of meals to vary their diet conveniently. The drop-in prepared meal kits may come in various sizes depending on the amount the user wishes to eat. The user removes the standard removable food tray 1336, and drops in a meal kit 1337. Food tray silicone drop-in dividers 1338 allow the user to change the space available to for example a small meal kit 1337 can be held in place with the insertion of a food tray silicone drop-in dividers 1338 to prevent the small meal kit 1337 from moving about inside the waterproof bento box 1300.

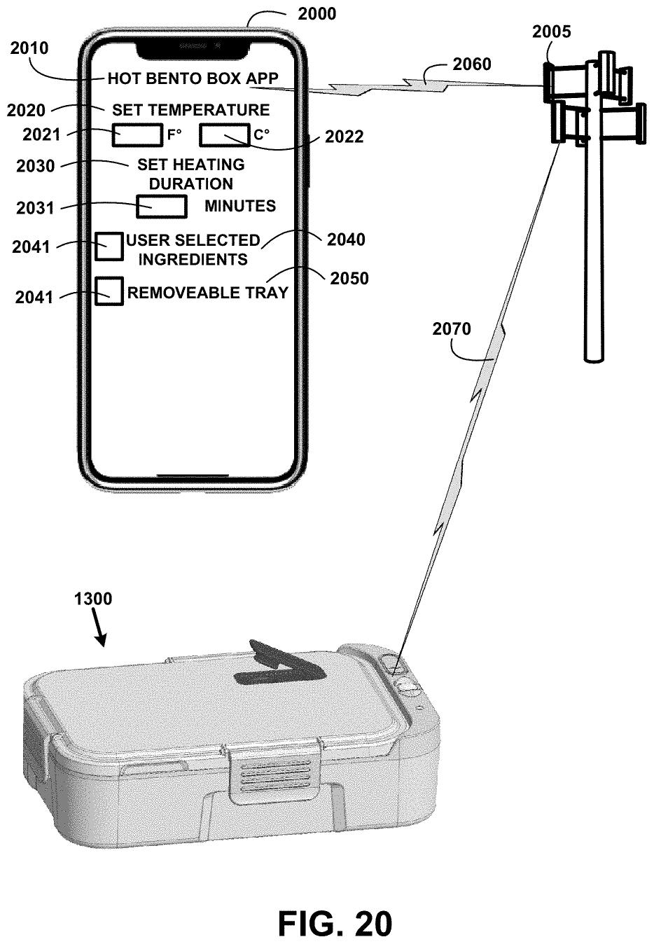

The waterproof bento box 1300 safety auto off when food tray is not installed 1339 prevents wasting power and the waterproof bento box 1300 from overheating without food to absorb the heat. Additional features are pivoting heat pads on the bottom and sides that automatically move into place when a tray is installed 1340. This provides even heating of the food. Adjustable temperature settings 1341 allow the user to heat various food types at various temperatures appropriate for the food without burning. This further allows a user to adjust the temperature to keep the food warm should the user's meal be interrupted for a period of time. A timer 1342 may be set based on user knowledge of what is a reasonable time the user feels is needed to heat the particular meal. The user may not be in near proximity to the waterproof bento box 1300 and can utilize the full app control of the device with recipes, location tracking, image and comment data upload/storage 1343 with a hot bento box app 2010 of FIG. 20 installed on the user's digital device for example a smart phone. The hot bento box app 2010 of FIG. 20 includes stored recipes that can guide the user on temperatures, timing and other aspects of heating their meal. The user may set the waterproof bento box 1300 timer to begin heating the meal for example 15 minutes later so that the meal is heated when the user can access the waterproof bento box 1300 of one embodiment.

### A Replaceable Tray Bento Box:

FIG. 14 shows for illustrative purposes only an example of a replaceable tray bento box of one embodiment. FIG. 14 shows an embodiment of a removable tray bento box 1400 with a hinged cover 1415. The hinged cover 1415 is secured when closed with a hinged cover latch 1430. A removable tray 1420 may be placed within the removable tray bento box 1400. Upon placing the removable tray 1420 in the removable tray bento box 1400 pivot heat panels 1405 automatically adjust their position to provide heat to the removable tray 1420. The removable tray 1420 may include any number of meal ingredients to suit the user and provide a variety of meal options to the user. Additionally the removable tray 1420 is disposable making cleanup quick and easy for the user of one embodiment.

### A Removable Battery:

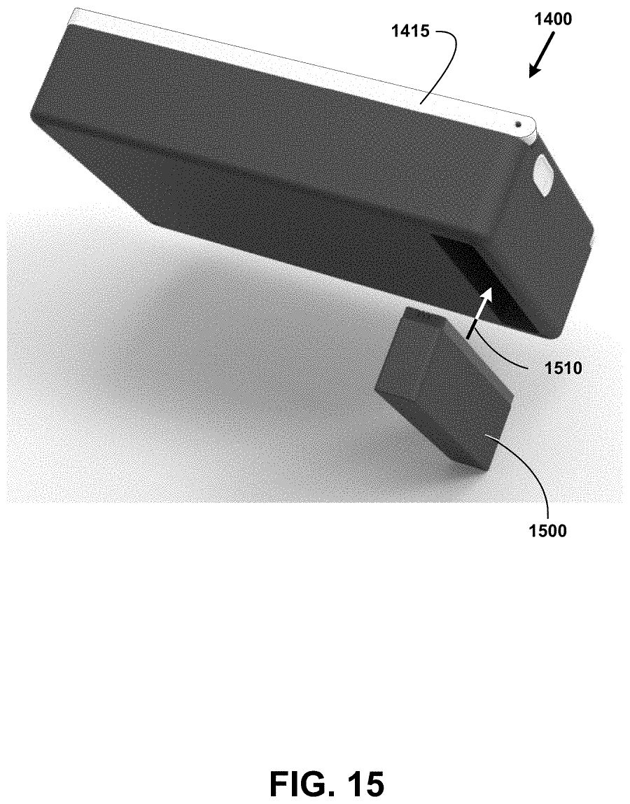

FIG. 15 shows for illustrative purposes only an example of a removable battery of one embodiment. FIG. 15 shows the removable tray bento box 1400 with the hinged cover 1415. Power in one instance is provided with a removable battery 1500. The removable battery 1500 may be rechargeable to allow the user multiple uses of the removable battery 1500. The removable battery 1500 is placed for use with insertion of removable battery 1510 into the bottom of the removable tray bento box 1400 of battery receptacle that includes the power circuitry of one embodiment.

### An Integral Tray:

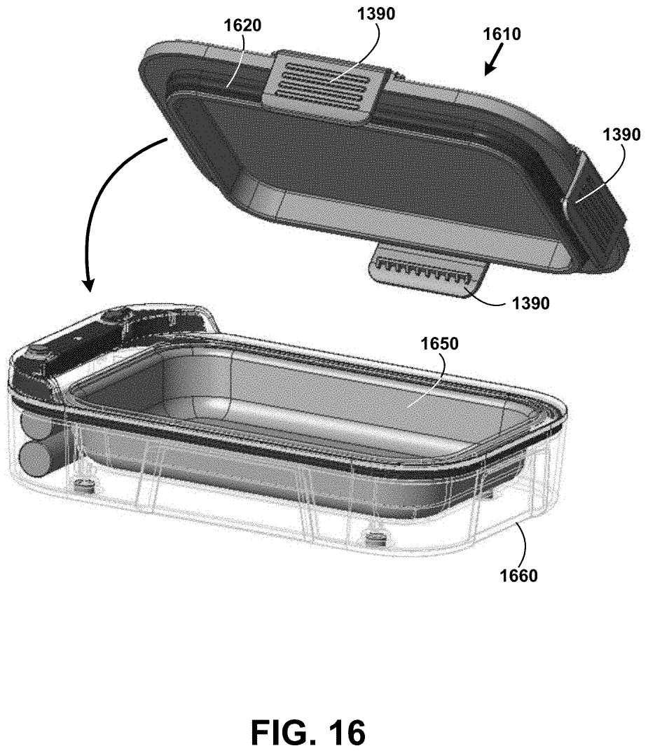

FIG. 16 shows for illustrative purposes only an example of an integral tray of one embodiment. FIG. 16 shows an integral tray 1650 in position within a transparent box image 1660 for ease of visibility. A plurality of a latch 1390 secures a removable cover 1610 to the box. The removable cover 1610 includes an O-ring 1620 to create a seal of the removable cover 1610 to the box. The O-ring seal prevents the contents from contamination and spillage of one embodiment.

### A Temperature Display:

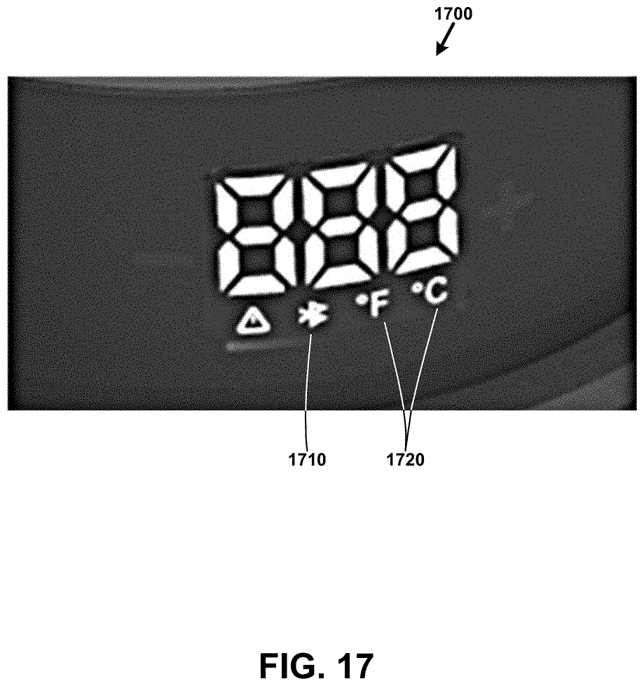

FIG. 17 shows for illustrative purposes only an example of a temperature display of one embodiment. FIG. 17 shows a temperature display 1700 that is integrated into the bento box. The temperature display 1700 shows the temperature within the bento box when heating. The temperature settings can be made in Fahrenheit or Celsius F.° or C.° indicator 1720 showing which temperature scale the user has selected. The temperature may be set with the hot bento box app 2010 of FIG. 20. In the instance the user wishes to set the temperature or other control with the hot bento box app 2010 of FIG. 20 the temperature display 1700 will highlight a connection to a wireless communications technology device including Bluetooth® indicator 1710 and for including voice activated commands of one embodiment.

### A Rechargeable Battery:

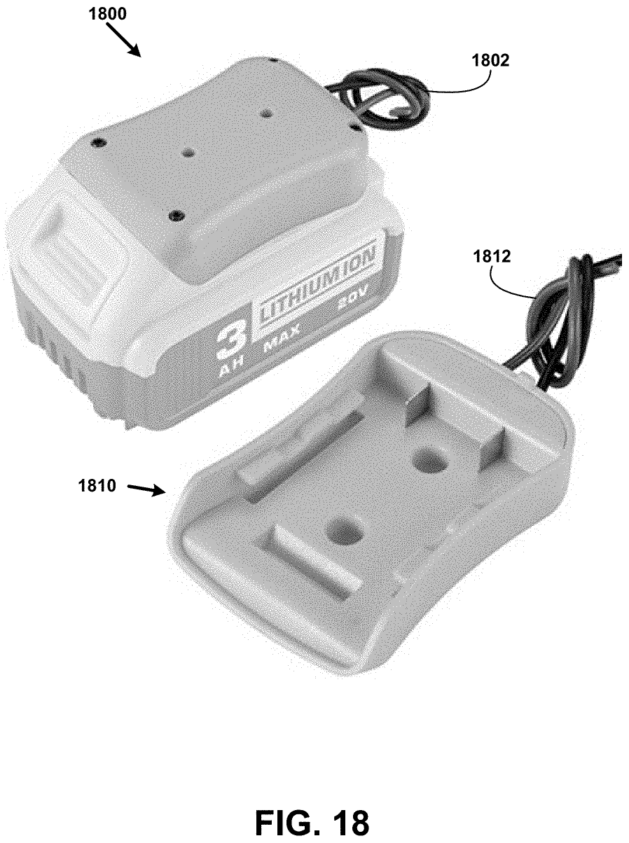

FIG. 18 shows for illustrative purposes only an example of a rechargeable battery of one embodiment. FIG. 18 shows a tool battery 1800 and tool battery cord 1802. As described in FIG. 13 a tool battery adapter 1810 with a tool battery adapter cord 1812 allows the user to use the tool battery 1800 to power the bento box. This provides the user with more options to acquire a rechargeable battery that will power the bento box. In some instances for example the user may be working in remote area some distance from stores and the option of using a tool battery 1800 will ensure the user of a heated meal of one embodiment.

### Bento Box Cross Section Markers:

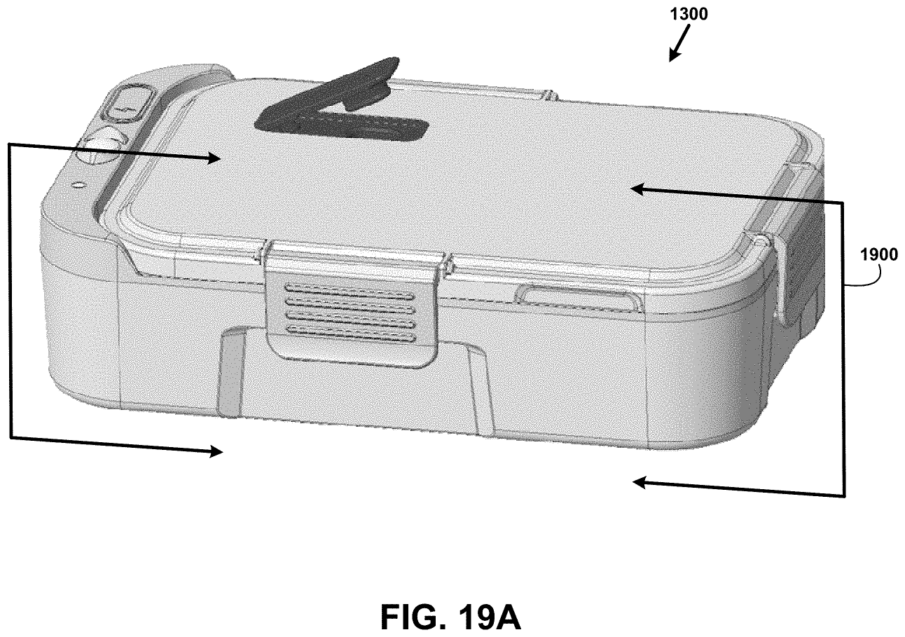

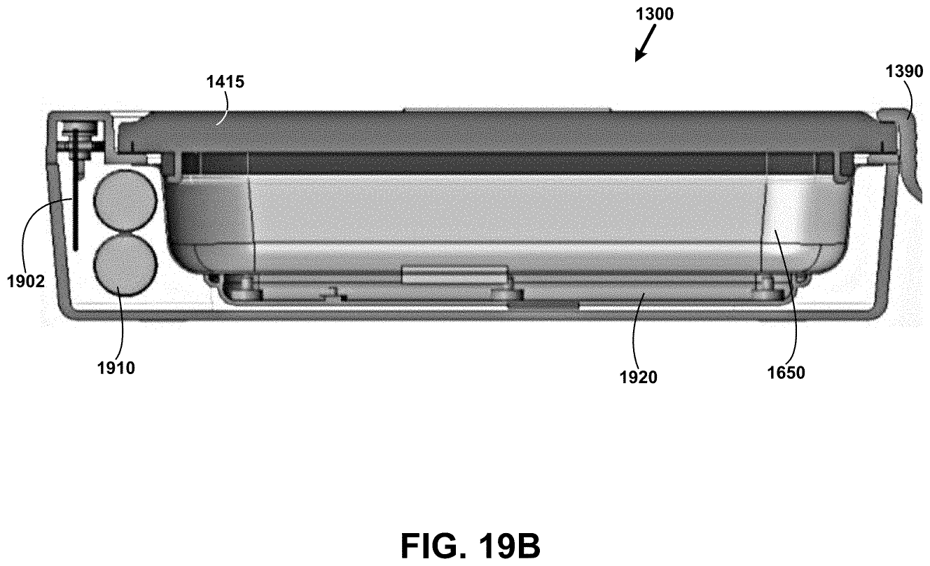

FIG. 19A shows for illustrative purposes only an example of bento box cross section markers of one embodiment. FIG. 19A shows cross section markers 1900 with the waterproof bento box 1300. The cross section markers 1900 indicate the region of the waterproof bento box 1300 in a cross section that is described in FIG. 19B of one embodiment.

### Bento Box Cross Section:

FIG. 19B shows for illustrative purposes only an example of bento box cross section of one embodiment. FIG. 19B shows a cross section of the waterproof bento box 1300. The cross section allows views of a vertical printed circuit board assembly (PCBA) 1902 that directs power distribution and other functions. Also shown are a battery pack 1910, the hinged cover 1415 and latch 1390. The bottom heating element 1920 is shown below the integral tray 1650. The bottom heating element 1920 covers the entire bottom surface area of the integral tray 1650. This provides even heating of the contents in both the integral tray 1650 and the removable tray 1420 of FIG. 14 when in use of one embodiment.

### Hot Bento Box App:

FIG. 20 shows for illustrative purposes only an example of hot bento box app of one embodiment. FIG. 20 shows the waterproof bento box 1300 wirelessly connected for communication between the waterproof bento box and hot bento box app 2070. In one embodiment a cellular tower 2005 provides the signal system for the bidirectional communication with a hot bento box app 2060. In another embodiment the signal system can be WIFI, RFID, NFC and others.

A user digital device 2000 with the hot bento box app 2010 may be used to set temperature 2020. The user sets the temperature in F.° 2021 with an option for C.° 2022. The user may set heating duration 2030 entering in the number of minutes 2031. The may be heating user selected ingredients 2040 so indicating with the check box 2041. The user may optionally select a removable tray 2050 with a check box 2041. The hot bento box app 2060 as requested by the user may additionally provide stored recipes that can guide the user on temperatures, timing and other aspects of heating their meal. The hot bento box app 2060 also provides location tracking, image and comment data upload/storage and other features to assist the user of one embodiment.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A food warmer device, comprising:
an integrated heat tray insert with electrical components configured for warming food placed in a food container;
a plurality of heat dispersing elements configured for generating heat in the heat tray insert;
a control printed circuit board assembly coupled to the heat tray insert including digital devices configured for activating and controlling heat tray insert electrical components and regulating the plurality of heat dispersing elements;
a temperature control device coupled to the control printed circuit board assembly configured for regulating heat temperatures generated from the plurality of heat dispersing elements;
at least one rechargeable battery pack coupled to the control printed circuit board assembly configured for supplying electrical power to the heat dispersing elements and other electrical components;
a food warming system app configured for installation into the control printed circuit board assembly, wherein the food warming system app installed on a user digital device allows the user to operate full control of the food warming device including access to recipes, device location tracking, image and comment data upload/storage; and
at least one cellular connectivity device and transceiver coupled to the control printed circuit board assembly configured for transmitting food status information to a user and receiving user instructions from a user digital device using a food warming or cooking system application.

2. The food warmer device of claim 1, further comprising control printed circuit board assembly coupled cellular, Bluetooth® and Wi-Fi connectivity devices configured for providing communication and control alternatives to the user including voice activated commands from the food warming system app.

3. The food warmer device of claim 1, further comprising a food grade silicone coating applied to the plurality of heat dispersing elements.

4. The food warmer device of claim 1, further comprising ultraviolet lights coupled to the heat tray insert for treating food placed in the heat tray insert to kill bacteria, viruses and other food borne pathogens and sterilize the food before, during and after the warming processes.

5. The food warmer device of claim 1, further comprising the heat tray and food container configured in shapes and sizes for various food types and natures including square, round, oblong and other shapes and sizes and wherein interior space is compartmentalized to separate foods.

6. The food warmer device of claim 1, further comprising food warming system devices configured for specific user activities including travel in a commercial airlines wherein the rechargeable battery pack is of a type and design that meet TSA regulations, the food container seals when closed to prevent any leakage.

7. The food warmer device of claim 1, further comprising food warming system cover clasps are configured to be child-proof and cannot be accidentally opened by contact with other objects.

8. An apparatus, comprising:
a plurality of heat elements configured to release when a food tray is removed from a container and pivot into contact position when a food tray is installed in the container;
at least one food tray configured to be removable from a container configured with a plurality of the heat elements;
a plurality of safety latches configured to prevent the container plurality of the heat elements from being turned on when no tray is installed;
a single use food tray configured to be preloaded with a drop-in prepared meal kits and to be placed in the container for heating;
a control printed circuit board assembly configured for controlling a heat temperature and heating time to allow cooking, warming and temperature maintenance;
a pressure equalization valve integrated into a waterproof cover configured for preventing pressure build up from heating the food contents;
a 3 way power supply configured to provide 110-240 v ac, 12 v dc, and battery power with independent protective circuits and resistors for each power source; and
a digital app configured to provide full control of the container functions from a user digital device.

9. The apparatus of claim 8, further comprising the plurality of heat elements configured for contact with a bottom surface of a food tray and two long sides of the food tray.

10. The apparatus of claim 8, further comprising adjustable food tray silicone drop-in dividers configured to allow sectionalization of the container for various single use food tray sizes, including the drop-in prepared meal kits wherein the standard integral food tray is removed and a drop-in meal kit is placed in the container.

11. The apparatus of claim 8, further comprising the food container made with stainless steel and alternatively with aluminum interior insulated walls with an exterior plastic jacketing.

12. The apparatus of claim 8, further comprising control a printed circuit board assembly configured for coupling to a wireless communications technology device.

13. The method of claim 1, further comprising a pressure equalization valve installed in the cover to alleviate pressure when the cover is closed, release pressure from steam, improve conductive circulation to decrease heating times and increase attainable temperatures, wherein the pressure equalization valve will automatically open to release excessive steam buildup.

14. The apparatus of claim 8, further comprising the control printed circuit board assembly configured for including at least one digital processor, at least one digital memory device, at least one database; at least one infrared thermometer coupled to the PCBA, at least one chemical vapor sensing device, at least one circuit coupled to the food container cover, at least one circuit coupled to at least one digital temperature display, at least one circuit coupled to an alert light coupled to the cover, and at least one circuit coupled to a temperature control selection device mounted on the heat tray insert mounting ledge.

15. A method, comprising:
warming food in a removable integral heat tray insert of a food container;
generating heat in the food container using electrical impedance of a plurality of pivoting heat pads on bottom and sides that automatically move into place when a heat tray is installed;
using a control printed circuit board assembly coupled to a power button for activating and controlling electrical components including the plurality of heat dispersing elements, adjustable temperature settings and timer controls to allow cooking, warming and temperature maintenance;
adjusting heat temperatures from the plurality of heat dispersing elements for warming food to a comfortable and safe heat level;
providing a waterproof power button with protective ridges including a double tap requirement to prevent accidentally turning on;
providing a digital display and adjustment buttons to control temperature and time;
coating the stainless steel and alternatively aluminum food tray surface with a Teflon™ non-stick coating;
using at least one rechargeable battery pack coupled to the control printed circuit board assembly with a power button for activating electrical components including the plurality of heat dispersing elements; and
transmitting food status information to a user and receiving user instructions from a user digital device using a food warming system app which includes a timer and adjustable heat control.

16. The method of claim 15, further comprising using at least one rechargeable battery pack including a Lithium ion pack, Lithium Polymer (LiPo) Rechargeable Battery, rechargeable aluminum-based batteries, rechargeable nickel-iron battery and other rechargeable battery types.

17. The method of claim 15, further comprising using a battery that may be permanently installed or removable and replaceable.

18. The method of claim 15, further comprising using at least one adapter to allow the use of popular hand tool batteries as power source.

19. The method of claim 15, further comprising using 110-240 volt AC power source, 12V DC power source or battery with each input power source having its own protective safety circuitry including a safety auto off when a food tray is not installed.

20. The method of claim 15, further comprising food warming system devices configured for keeping foods placed inside cold.
